(19) United States
(12) Patent Application Publication
(10) Pub. No.: US 2007/0293113 A1
(43) Pub. Date: Dec. 20, 2007

(54) HEAT ABSORPTIVE BI-LAYER FIRE RESISTANT NONWOVEN FIBER BATT

(75) Inventor: Steven E. OGLE, Cary, NC (US)

Correspondence Address: CONLEY ROSE, P.C., 5601 GRANITE PARKWAY, SUITE 750, PLANO, TX, 75024, US

(73) Assignee: L&P Property Management Company, South Gate, CA (US)

(21) Appl. No.: 11/762,656

(22) Filed: Jun. 13, 2007

Related U.S. Application Data
(60) Provisional application No. 60/813,378, filed on Jun. 14, 2006.
(60) Provisional application No. 60/813,541, filed on Jun. 14, 2006.

(51) Int. Cl. B32B 3/10; B32B 5/26; D04H 1/00

(52) U.S. Cl. 442/414; 442/381; 428/131; 442/415

(57) ABSTRACT

Disclosed is a heat absorptive bi-layer FR nonwoven fiber batt and an associated method of enhancing the fire resistance characteristic of a product employing the same. The heat absorptive bi-layer FR nonwoven fiber batt includes a heat reactive layer and a barrier layer having a lower side surface disposed against an upper side surface of the heat reactive layer. In response to a heat source located beyond the barrier layer, a cavity may form in the heat reactive layer, extending from the upper side surface to an interior side surface thereof. The cavity is fully enclosed, within the heat absorptive bi-layer FR nonwoven fiber batt, by the lower side surface of the barrier layer.

### CROSS-REFERENCE TO RELATED APPLICATIONS

This application is related to and claims priority to U.S. Provisional Patent Application Ser. No. 60/813,378 (Atty. Docket No. 4003-08201) entitled “Method of Manufacturing A Durable Fire Resistant Nonwoven Fiber Batt Using Non-Inherently Fire Resistant Fibers,” and to U.S. Provisional Patent Application Ser. No. 60/813,541 (Atty. Docket No. 4003-21501) entitled “Heat Absorptive Bi-Layer Fire Resistant Nonwoven Fiber Batt,” both of which have been assigned to the Assignee of the present application and are hereby incorporated by reference as if reproduced in the entirety.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE DISCLOSURE

The present disclosure relates to fire resistant (FR) nonwoven fiber batts and, more particularly, to a heat absorptive bi-layer FR nonwoven fiber batt formed from a barrier-type FR batt and a heat-reactive-type FR nonwoven fiber batt.

### BACKGROUND

FR products are desirable in a wide variety of applications. Products for both private occupancy such as homes and public occupancy such as health care facilities, convalescent care homes, college dormitories, residence halls, hotels, motels and correctional institutions are often governed by regulations which require the products meet certain FR standards. This is particularly true when bedding and upholstered products are concerned. For example, California Technical Bulletins (TBs) 116 and 603 set FR standards for upholstered furniture and mattress/box spring sets, respectively. Components having certain FR characteristics are also needed in a wide array of other applications where fire safety is a concern, including, but not limited to apparel, fire safety gear, vehicle seating and insulators used in a wide variety of applications.

FR is a relative term which is typically based upon a determination as to whether a specific product satisfies a particular FR standard. For example, a mattress may satisfy the requirements of 16 CFR §1632 (the Federal Standard for the resistance of a mattress or mattress pad to combustion which may result from a smoldering cigarette) but fail to meet the requirements of TB 603. Such a mattress would be characterized as FR for purposes of 16 CFR §1632 but non-FR for purposes of TB 603. Taken as a class, however, all FR products tend to minimize the amount and rate of heat released from the product upon contact with an open flame or other source of ignition. The rate of heat released by an FR product is generally viewed as both an indication of the intensity of the fire generated by the FR product as well as how quickly the fire will spread. Slowing the spread of fire advantageously increases the amount of response time for a person in dangerous proximity to the fire to move to a place of safety and for a fire department or other public or private safety agency to successfully extinguish the fire.

In the bedding, upholstery and other industries, foams and nonwoven fibers are often used in mattresses, sofas, chairs, and seat cushions, backs and arms. Traditionally, urethane foam has been combined with other types of cushioning materials such as cotton batting, latex rubber, and various nonwoven fibers in order to impart desirable comfort, loft and durability characteristics to a finished product. However, urethane foam is extremely flammable and must be chemically treated or coated to impart FR properties thereto. As it is widely recognized as having FR properties, neoprene foam is often used in bedding and upholstery products as well. However, as both neoprene foam and urethane foam which has been chemically treated to impart FR properties thereto are relatively expensive, cost constraints often limit the applications for which neoprene foam and chemically treated urethane are commercially suitable.

Synthetic and natural woven fibers are often used to construct mattresses and upholstery. Such fibers are inherently lightweight and therefore easy to ship, store and manipulate during processing. Many will also resist burning and are, therefore, useful when manufacturing FR mattresses and upholstery. For example, when subjected to high temperatures, many synthetic fibers, particularly polymer fibers and specifically dry polyester fibers, tend to (1) melt and drip rather than burn and (2) physically retreat (or “shrink away”) from an open flame or other source of heat. As used herein, the term “heat-reactive-type fibers” shall refer to those fibers which undergo a physical displacement, away from an open flame or other source of heat, upon application of the open flame or other source of heat thereto. For example, the aforedescribed response of polyester fibers to heat clearly establishes polyester fiber as a heat reactive-type fiber. It should be clearly understood, however, that the foregoing is provided purely by way of example and that there are a wide variety of types of fibers other than those specifically identified herein which may properly be identified as heat-reactive type fibers suitable for the uses contemplated herein.

However, the use of polyester fibers alone does not always provide mattresses or upholstery with sufficient protection from fire. As a result, the use of other fibers has also been proposed. As used herein, the term “inherent-type FR fibers” refers to those fibers which resist combustion as a result of an essential characteristic of the fiber. Conversely, the term “non-inherent-type FR fibers” refers to those fibers that are generally considered to be non-FR but have been treated with a fire retardant to become FR. As further used herein, the term “charring fibers” refers to fibers that resist combustion and instead form a stable structure in response to exposure of the fibers to an open flame. Both inherent-type FR fibers and non-inherent-type FR fibers may be charring fibers. Periodically, charring fibers are referred to as “barrier fibers” in that a nonwoven fiber batt which incorporates charring fibers as a component thereof often serves as a barrier which shields underlying components from the open flame causing the fibers of the nonwoven fiber batt to char.

To enhance the FR characteristic thereof, one FR fiber that has been proposed for use as a component of nonwoven fiber batts typically found in mattresses, upholstery or the like is a fiber commonly known as oxidized polyacrylonitrile (PAN). When exposed to an open flame, oxidized PAN forms a stable char structure. As a result, an FR nonwoven fiber batt incorporating oxidized PAN as a component thereof would maintain its structural integrity for a longer period of time, thereby enabling the FR nonwoven fiber batt to serve as a barrier which shields underlying components from the open flame. Thus, oxidized PAN may be properly identified as either a charring or barrier fiber. Further, as the FR characteristic of oxidized PAN results from an essential characteristic thereof, oxidized PAN may be further properly identified as either an inherent-type FR charring fiber or an inherent-type FR barrier fiber. It should be clearly understood, however, that the foregoing is provided purely by way of example and that there are a wide variety of fibers other than those specifically identified herein may properly be identified as either inherent-type FR fibers or non-inherent type FR fibers suitable for the uses contemplated herein.

One obstacle to the use of oxidized PAN as a component of inherent-type FR nonwoven fiber batts such as those used in many mattress, upholstery and other nonwoven fiber applications is that its high cost may result in products that are too expensive to successfully compete in the marketplace. Another drawback is that the oxidized PAN fibers themselves are difficult to process into fiber batts for use as a barrier layer and/or filling. As a result, oxidized PAN fibers are not always particularly well suited for use in the aforementioned applications. More specifically, as oxidized PAN fibers are relatively low in weight and specific gravity, traditional carding methods used to form nonwoven fiber batts are much more difficult. In addition, oxidized PAN fibers are so-called dead fibers as they have relatively little resilience and loft and are generally incompressible. As a result, nonwoven fiber batts formed using oxidized PAN fibers are often unsuitable for those bedding, upholstery and other applications where loft and comfort are desired. Finally, oxidized PAN fibers are also black in color and may, therefore, be unsuitable in applications where aesthetics are of particular concern, for example, in products which require a light color beneath a light decorative upholstery or mattress layer.

Various solutions to the use, in nonwoven fiber batts, of FR fibers having one or more of the shortcomings associated with the use of oxidized PAN fibers have been proposed. For example, International Publication No. WO 01/6834 A1 to Ogle et al. discloses a method of forming a bi-layer nonwoven fire combustion modified batt for use in a mattress. The fire combustion modified batt disclosed in WO 01/6834 is comprised of a first, FR, layer formed from a first blend of black oxidized PAN fibers and nonwoven fibers, specifically, white polyester carrier fibers and white polyester binder fibers and a second layer formed from a second blend of nonwoven fibers, specifically, white polyester carrier fibers and white polyester binder fibers. The resultant fire combustion modified batt has a distinctly gray colored side (the oxidized PAN layer) to be disposed above any other interior components of the mattress and a distinctly white, outwardly facing side (the nonwoven fiber layer) to be disposed against the ticking of the mattress. By positioning the bi-layer nonwoven fire combustion modified batt such that the grey oxidized PAN layer is disposed against the interior components of the mattress and the white polyester layer is disposed against the ticking of the mattress, the white nonwoven fiber layer shields the gray oxidized PAN layer from sight, thereby preventing the grey oxidized PAN layer from detracting from the aesthetics of the mattress.

When exposed to an open flame, the heat-reactive polyester fibers of the outer, nonwoven fiber layer rapidly retreat away from the flame, quickly exposing the inner, oxidized PAN layer to the open flame. Likewise, when exposed to the open flame, the polyester fibers of the oxidized PAN layer also retreat rapidly away from the flame. Here, however, the retreat of the polyester fibers results in the creation of a layer of inert oxidized PAN that acts as a flameproof shield against the exothermic oxidation of any combustible material located beneath the oxidized PAN layer, thereby enhancing the FR characteristic of the mattress. However, while the oxidized PAN layer acts as a shield which protects underlying combustible material from coming into contact with the open flame, the oxidized PAN layer is less successful in preventing heat generated by the open flame from being transmitted, through the oxidized PAN layer, to the underlying combustible material. It should be readily appreciated that, should sufficient heat be transferred to the underlying combustible material, the material will either ignite or otherwise react in a manner, for example, by physically retreating away from the heat source, which tends to increase the likelihood of a general failure of the structure of the mattress-an event which will quickly speed consumption of the mattress by the open flame.

What is sought, therefore, is a bi-layered FR nonwoven fiber batt capable of serving as both a flame barrier and a heat barrier for combustible materials disposed thereagainst.

### SUMMARY

In one aspect, the present disclosure is directed to a heat absorptive bi-layer fire resistant (“FR”) nonwoven fiber batt for use with a product having a combustible layer, comprising a barrier layer having a distal side surface distal to the combustible layer and a proximal side surface proximal to the combustible layer; and a heat reactive layer having a distal side surface distal to the combustible layer and a proximal side surface proximal to the combustible layer; wherein the proximal side surface of the barrier layer is disposed against the distal side surface of the heat reactive layer. In one embodiment, the barrier layer comprises FR fibers that neither melt nor flow when in contact with heat; and the heat reactive layer comprises fibers that physically retreat in response to the application of heat. In another embodiment, in response to the application of heat originating from a heat source in distal proximity to the barrier layer, a portion of the heat reactive layer which experiences heat from the heat source retreats to form an aperture that impedes thermal transfer of heat from the heat source to the proximal side of the heat-reactive layer. In yet another embodiment, the barrier layer comprises an FR nonwoven fiber batt that does not physically retreat, but maintains structural integrity, in response to the application of heat; and the heat reactive layer comprises a nonwoven fiber batt that physically retreats in response to the application of heat.

In still another embodiment, in response to the application of heat originating from a heat source in distal proximity to the barrier layer, the barrier layer is operable to shield the heat reactive layer from direct contact with the heat source while permitting a portion of the heat generated by the heat source to radiate through; and the heat reactive layer is operable to form an aperture that impedes thermal transfer of heat from the heat source to the proximal side of the heat reactive layer as a portion of the heat reactive layer experiencing heat retreats. The aperture generally may extend from the distal side surface of the heat reactive layer to an interior side surface thereof (or in a worst case scenario, to the proximal side surface of the heat reactive layer in proximity to the combustible layer). In another embodiment, the product further comprises a ticking; the ticking is disposed against the distal side surface of the barrier layer; and the proximal side surface of the heat reactive layer is disposed against the combustible layer.

In an embodiment, the FR nonwoven fiber batt of the barrier layer may comprise inherently FR fibers, and the inherently FR fibers may also be hybrid fibers that neither melt nor flow when in contact with heat. The hybrid fibers may comprise Visil® fibers as well. Alternatively, the inherently FR fibers may comprise oxidized polyacrylonitrile (“PAN”) fibers. The FR nonwoven fiber batt of the barrier layer may comprise FR rayon fibers and/or charring fibers as an alternative embodiment, and the charring fibers may comprise durable FR rayon. In another embodiment, the FR nonwoven fiber batt of the barrier layer may comprise non-inherently FR fibers treated with a fire retardant chemical. The barrier layer may be operable to release gas and steam when exposed to the heat source. Additionally, the nonwoven fiber batt of the heat reactive layer may comprise polyester fibers.

In another aspect, the present disclosure is directed to a method for enhancing the fire resistance characteristics of a product having a combustible layer, comprising positioning a heat reactive layer having a distal side surface distal to the combustible layer and a proximal side surface proximal to the combustible layer, with the proximal side surface of the heat reactive layer disposed in proximity to the combustible layer; and positioning a barrier layer having a distal side surface distal to the combustible layer and a proximal side surface proximal to the combustible layer, with the proximal side surface of the barrier layer disposed in proximity to the distal side surface of the heat reactive layer. In an embodiment, the method may further comprise joining the barrier layer and the heat reactive layer to form a heat absorptive bi-layer fire resistant fiber batt. In yet another embodiment, the product may further comprise a ticking, and the method may further comprise positioning the ticking, with the ticking disposed in proximity to the distal side surface of the barrier layer.

Still another aspect of the present disclosure is direct to a product comprising a combustible layer; a ticking; and an FR layer; wherein the FR layer comprises a barrier layer and a heat reactive layer; the heat reactive layer comprises a nonwoven fiber batt operable to physically retreat in response to the application of heat; the barrier layer comprises an FR nonwoven fiber batt operable to not physically retreat, but maintain structural integrity, in response to the application of heat; and the FR layer is disposed between the combustible layer and the ticking. In an embodiment, the heat reactive layer is disposed in proximity to the combustible layer; and the barrier layer is disposed in proximity to the heat reactive layer and distal to the combustible layer. In another embodiment, the barrier layer comprises a distal side surface distal to the combustible layer and a proximal side surface proximal to the combustible layer; the heat reactive layer comprises a distal side surface distal to the combustible layer and a proximal side surface proximal to the combustible layer; and the proximal side surface of the barrier layer is disposed in proximity to the distal side surface of the heat-reactive layer.

In one embodiment, disclosed herein is a heat absorptive bi-layer FR nonwoven fiber batt which includes a heat reactive layer and a barrier layer having a lower side surface disposed against an upper side surface of the heat reactive layer. Formed in the heat reactive layer is a cavity which extends from the upper side surface to an interior side surface thereof. The cavity is fully enclosed, within the heat absorptive bi-layer FR nonwoven fiber batt, by the lower side surface of the barrier layer. In one aspect, the cavity extends from the upper side surface of the heat reactive layer to a lower side surface thereof.

In another embodiment, disclosed herein is a method of enhancing the fire resistance characteristic of a product. In accordance with the disclosed method, a heat absorptive bi-layer FR nonwoven fiber batt comprised of a heat reactive layer and a barrier layer is formed such that a first side surface of the barrier layer is disposed against a second side surface of the heat reactive layer. The heat absorptive bi-layer FR nonwoven fiber batt is then positioned, relative to the product, such that a first side surface of the heat absorptive bi-layer FR nonwoven fiber batt is disposed against an exterior side surface of the product. In one aspect, the product is a mattress core and, in another aspect, the method further includes positioning a provided ticking such that a first side surface of the ticking is disposed against the second side surface of the barrier layer.

### DESCRIPTION OF THE DRAWINGS

For a more complete understanding of the present invention, and for further details and advantages thereof, reference is now made to the accompanying drawings, in which:

FIG. 1 is a flow chart of a method of forming a heat absorptive bi-layer FR nonwoven fiber batt constructed in accordance with the teachings disclosed herein.

FIG. 2 is a schematic top plan view of a processing line for forming the heat absorptive bi-layer FR nonwoven fiber batt in accordance with the method of FIG. 1.

FIG. 3A is a schematic side view of a thermal bonding apparatus forming part of the processing line of FIG. 2.

FIG. 3B is a schematic side view of a thermal bonding apparatus suitable for use in place of the thermal bonding apparatus of FIG. 3A.

FIG. 4 is a partially cutaway view of a mattress which incorporates the heat absorptive bi-layer FR nonwoven fiber batt formed in accordance with the method of FIG. 1.

FIG. 5A is an expanded partial side view of the heat absorptive bi-layer FR nonwoven fiber batt of FIG. 4.

FIG. 5B is an expanded partial side view of an alternate embodiment of the heat absorptive bi-layer FR nonwoven fiber batt of FIG. 5A.

FIG. 6 is a cross-sectional view of the heat absorptive bi-layer FR nonwoven fiber batt of FIG. 5A which representatively illustrates the response of the heat absorptive bi-layer FR nonwoven fiber batt of FIGS. 4 and 5A-B upon application of an open flame thereto.

### DETAILED DESCRIPTION

It should be clearly understood that the teachings set forth herein are susceptible to various modifications and alternative forms, specific embodiments of which are, by way of example, shown in the drawings and described in detail herein. It should be clearly understood, however, that the drawings and detailed description set forth herein are not intended to limit the disclosed teachings to the particular form disclosed. On the contrary, the intention is to cover all modifications, equivalents and alternatives falling within the spirit and scope of that which is defined by the claims appended hereto.

The method for forming a heat absorptive bi-layer FR nonwoven fiber batt 404 will now be described in greater detail. It should be noted, however, that the process set forth hereinbelow includes a thermal bonding process. It should be clearly understood, however, that a resin saturated curing process may be employed in place of the disclosed thermal bonding process. It should be further understood that a variety of other bonding processes, for example, needle-punching, hydro-entangling and mechanical bonding, may also be suitable for bonding fibers together to form the disclosed heat absorptive bi-layer FR nonwoven fiber batt 404. Finally, it should be noted that the disclosed process for forming the heat absorptive bi-layer FR nonwoven fiber batt 404 is similar to the processes used to form a variety of other FR nonwoven fiber batts, for example, the FR nonwoven fiber batts disclosed in, among others, our co-pending U.S. patent application Ser. Nos. 10/221,638, 10/968,318, 10/968,339 and 11/088,657, all of which are assigned to the Assignee of the present application and hereby incorporated by reference as if reproduced in their entirety.

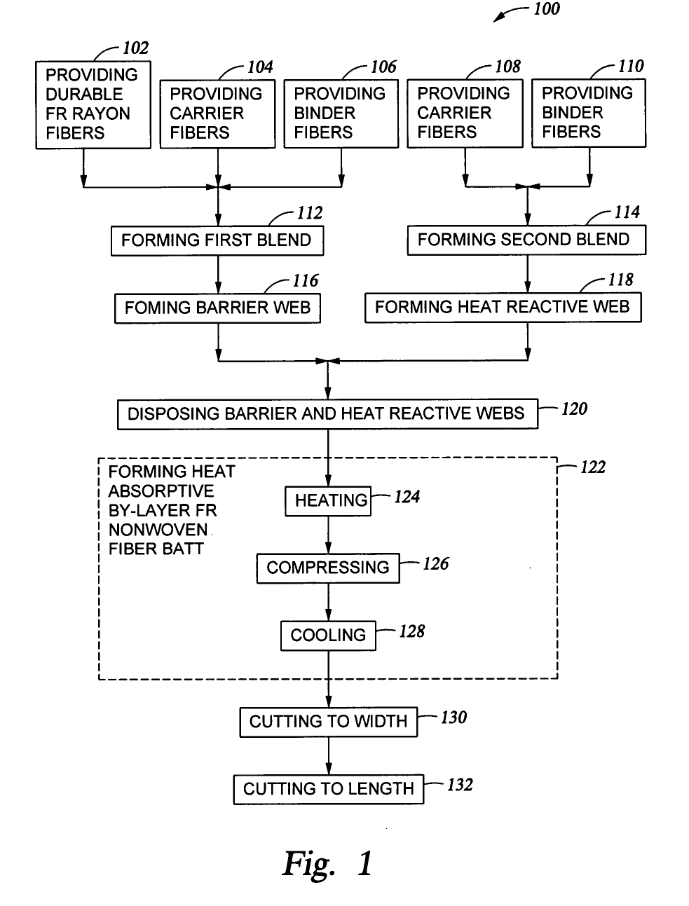

Referring now to FIG. 1, a thermal bonding process used to form a heat absorptive bi-layer FR nonwoven fiber batt constructed in accordance with the teachings of the present invention will now be described in greater detail. As may now be seen, the process 100 of forming the heat absorptive bi-layer FR nonwoven fiber batt 404 is commenced by providing the components to be used to form a first, barrier, web. Accordingly, first, second and third types of fibers are provided at 102, 104 and 106, respectively. The first type of fiber provided at 102 is an FR fiber, the second type of fiber provided at 104 is a carrier fiber and the third type of fiber provided at 106 is a binder fiber. Preferably, the FR fiber is a barrier-type fiber.

In one embodiment, the barrier-type fiber is a charring fiber. It is fully contemplated that a wide variety of charring fibers are suitable for the purposes disclosed herein. As previously set forth, a charring fiber is a fiber which, when exposed to an open flame, forms a stable char structure which enables an FR nonwoven fiber batt incorporating the charring fiber as a component thereof to maintain its structural integrity for a longer period of time, thereby enabling the FR nonwoven fiber batt to serve as a flame barrier. If a charring fiber is to be deployed as the barrier-type fiber, the charring fiber of choice is the treated cellulosic fiber commonly known as FR rayon. As used herein, the term “FR rayon” refers to rayon fibers treated by applying a suitable flame retardant chemical thereto, thereby effectively rendering the rayon fibers FR or, more specifically, non-inherently FR. FR rayon is particularly well suited for the purposes disclosed herein as it is a white fiber which, unlike black FR fibers such as oxidized PAN, will not adversely affect the aesthetics of a product which incorporates an FR nonwoven fiber batt having FR rayon as a component thereof.

If FR rayon is employed as a component of the barrier web, the FR rayon of choice is a durable FR rayon such as that disclosed in our co-pending provisional U.S. Patent Application Ser. No. 60/813,378 (Atty. Docket No. 4003-08201), hereby incorporated by reference as if reproduced in its entirety. In that durable FR rayon fibers tend to better maintain their FR characteristic, durable FR rayon fibers are generally preferred over non-durable FR rayon fibers in that the FR characteristic of the fiber will resist the degradation over time While, as disclosed herein, durable FR rayon fibers are provided at 102, it is fully contemplated that, in an alternate embodiment not disclosed herein, the FR rayon fibers provided at 102 may be non-durable FR rayon fibers which are subsequently rendered durable during formation of the heat absorptive bi-layer FR nonwoven fiber batt. The process by which nondurable FR rayon fibers are rendered durable during the batt formation process is set forth in greater detail in the aforementioned co-pending provisional U.S. Patent Application Ser. No. 60/813,378 (Atty. Docket No. 4003-08201).

In another embodiment, it is contemplated that the FR barrier-type fibers to be employed are hybrid fibers, e.g., fibers that are part organic and part inorganic, for example, viscose staple fibers containing silicic acid is a hybrid fiber. One such fiber is Visil®, an FR fiber commercially available through Sateri Oy of Valkeakoski, Finland. Visil® is a permanently FR fiber that neither melts nor flows when in contact with heat or flame and is described in greater detail in U.S. Pat. No. 5,417,752, which is hereby incorporated by reference as if reproduced in its entirety.

In still other embodiments, it is contemplated that the FR fiber may be an inherently FR fiber, for example, oxidized polyacrylonitrile (PAN) or a non-inherently FR fiber (in which a fire retardant chemical is applied to non-FR fibers). Of course, while oxidized PAN is an inherently FR fiber functionally suitable for the purposes disclosed herein, its use is generally discouraged in view of its relatively high cost and dark color. Of course, the foregoing is but one example of a inherently FR fiber suitable for the purposes disclosed herein. Conversely, if a non-inherently FR fiber is selected, it is generally preferred that the fiber is processed to be a durable non-inherently FR fiber, for example, using the aforementioned process disclosed in provisional U.S. Patent Application Ser. No. 60/813,378 (Atty. Docket No. 4003-08201).

Typically, non-inherently FR fibers begin as conventional, i.e., non-FR, fibers, which are then treated with an FR chemical compound, most commonly, by either impregnated or coating the non-FR fibers with the FR chemical compound. Variously, the FR chemical compound may be wash durable or non-wash durable. Examples of wash durable FR chemical compounds suitable for the uses contemplated herein include the X-12 chemical compound manufactured by E.I. duPont de Nemours and Company of Wilmington, Del., the GUARDIAN series of specialty flame retardancy chemical compounds manufactured by Glo-Tex International, Inc. of Spartanburg, S.C. and the FR chemical compound disclosed in U.S. Pat. No. 3,997,699 entitled “Flame Resistant Substrates” and hereby incorporated by reference as if reproduced in its entirety. While it is contemplated that the FR chemical compound used to treat the FR fibers may be non-wash durable, non-wash durable treatments are not preferred because they lose the FR effectiveness when washed. Examples of non-wash-durable fibers may include FR viscose, such as VISIL® available from Sateri Oy and LENZING FR® available from Lenzing AG. Any of the fibers described above may also be treated with other chemicals such as antimicrobial chemicals, antioxidants, or dyes. The example fibers and FR chemicals set forth above are merely exemplary, and non-inherently FR fibers may comprise other fibers and FR chemicals, which are inherently included within the scope of this disclosure. After being treated with one or more fire retardant chemicals, the fibers (which by way of example may be cellulosic fibers such as rayon, cotton, jute, shoddy, wool, or silk) exhibit FR characteristics. A combination of various types of FR fibers could also be used in the barrier layer, with the various FR fibers homogeneously blended with the carrier and/or binder fibers.

As may be further seen in FIG. 1, the nonwoven fibers respectively provided at 104 and 106 and subsequently used, in combination with the FR rayon fibers provided at 102, to form the first blend at 112 include carrier fibers and binder fibers. Variously, the carrier and binder fibers can be natural or synthetic fibers. For example, thermoplastic polymer fibers such as polyester are synthetic fibers suitable for use as both the carrier and binder fibers. Of course, depending on the precise processing limitations imposed on the manufacturing process and the characteristics of the barrier web formed at 1 16 and/or the heat absorptive bi-layer FR nonwoven fiber batt formed at 122, other fibers may be suitable for the purposes contemplated herein.

In one embodiment, it is contemplated that a suitable fiber for use as the carrier fiber would be a Type 209 polyester fiber manufactured by KoSa of Wichita, Kans., or an equivalent. The Type 209 polyester fiber is a white fiber having a weight-per-unit-length of between 6 and 15 denier, a cut length of between 2 and 3 inches in length and a round, hollow, cross-section. Alternately, the carrier fiber may be a Type 295 polyester fiber, also manufactured by KoSa, or an equivalent. The Type 295 polyester fiber is a white fiber having a weight-per-unit-length of between 6 and 15 denier, a cut length of between ⅕ and 4 and a pentalobal cross-section. Carrier fibers typically are either hollow or solid (depending on functional needs such as loft). Preferably, the carrier fibers for this example would be optically bright for aesthetic purposes (since this may help to preserve a white product appearance even if the FR fiber has some other color or tint). Carrier fibers typically provide loft, provide resilience, provide structure, and/or allow effective formation of batts using traditional carding techniques. Of course, the foregoing disclosure of particular carrier fibers (and/or carrier fiber characteristics) is purely for purposes of illustration and should not be construed as a limitation in any manner. In this regard, it is fully contemplated that other nonwoven fibers are suitable for use as carrier fibers and are, therefore, within the scope of the present disclosure.

The binder fiber has a lower predetermined melting temperature relative to the predetermined melting temperature of the carrier fiber. It is an inherent characteristic of thermoplastic fibers such as polyester that they become sticky and tacky when melted, as that term is used herein. For purposes of illustrating the process by which the heat absorptive bi-layer FR nonwoven fiber batt is constructed, in the embodiment disclosed herein, it is contemplated that the binder fiber may be a Type 254 Celbond® polyester fiber, also manufactured by KoSa, or an equivalent. The Type 254 Celbond® polyester fiber is a bicomponent fiber with a polyester core and a copolyester sheath having a melting temperature of approximately 230° F. (110° C.). Of course, the foregoing disclosure of a particular binder fiber is purely for purposes of illustration and should not be construed as a limitation in any manner. In this regard, it is fully contemplated that other nonwoven fibers are suitable for use as binder fibers and are, therefore, within the scope of the present disclosure. For example, it is contemplated that a polyester copolymer binder fiber is suitable for use in place of the bicomponent binder fiber hereinabove disclosed. In some embodiment, it may also be possible to use a liquid adhesive/resin in place of binder fibers in order to bind the fibers together into a batt. Binder fibers are typically preferred, since they have good flammability characteristics (while such liquid adhesives are often quite flammable). If a liquid adhesive/resin (such as latex or PVC based adhesives) is used, it may be necessary to also employ an additive that reduces flammability (although such an additive would drive up costs).

Proceeding on to 112, the white charring fibers provided at 102, the white polyester carrier fibers provided at 104 and the white polyester binder fibers provided at 106 are mixed to form a first, generally homogeneous, blend. In the embodiment disclosed herein, it is contemplated that the first blend may be comprised of binder finders in an amount sufficient for binding the fibers of the first blend together upon application of heat at the appropriate temperature to melt the binder fibers. In one example, the binder fibers are in the range of approximately 5 percent to 50 percent by total volume of the blend. Preferably, the binder finders are present in the range of approximately 10 percent to 15 percent by volume for a high loft heat absorptive bi-layer FR nonwoven fiber batt and in the range of approximately 15 percent to 40 percent by volume for a densified heat absorptive bi-layer FR nonwoven fiber batt. The relative percent volume of charring fibers to carrier fibers in the remaining volume of the first blend may range from 15 percent to 85 percent. In the preferred embodiment, the relative percent volume of charring fibers to carrier fibers in the remaining volume of the first blend is about 50 percent to 50 percent. Thus, for example, a blend having 10 percent by volume of binder fibers and a 50 to 50 percent relative volume of charring fibers to carrier fibers in the remaining volume of the blend, the volume of charring fibers and carrier fibers in the blend is 45 percent each.

In another example, for a blend having 20 percent by volume of binder fibers and a 50 to 50 percent relative volume of charring fibers to carrier fibers in the remaining volume of the blend, the volume of charring fibers and carrier fibers is 40 percent each. In still another example, for a blend having 20 percent by volume of binder fibers and a 75 to 25 percent relative volume of charring fibers to carrier fibers in the remaining volume of the blend, the volume of charring fibers and carrier fibers in the blend is 60 percent and 20 percent, respectively. Of course, it is fully contemplated that blends having other percentages of binder, charring and carrier fibers are also within the scope of the invention. It is further contemplated that first blend need not necessarily include each of the aforementioned binder, carrier and charring fibers. For example, in some instances, it may be suitable to form the first blend of fibers without the inclusion of carrier fibers therein. Alternatively, it may be suitable in some instances to form the first blend of fibers without inclusion of binder fibers therein, if for example, some other bonding process is used to form the batt.

As may be further seen in FIG. 1, the method 100 further includes the formation of a second generally homogeneous blend of fibers at 114. To do so, carrier fibers are provided at 108, binder fibers are provided at 110 and the provided fibers mixed at 114 to form the second blend. The fibers used to form the second blend can be the same as or similar to those used to form the first blend at 112. For example, it is contemplated that the carrier fibers may be white polyester carrier fibers previously described herein and the binder fibers may be the white polyester binder fibers previously described herein. Of course, other synthetic or natural fibers can be used depending upon the precise processing limitations imposed and the characteristics of the heat reactive web formed at 118 or the heat absorptive bi-layer FR nonwoven fiber batt formed at 122.

Proceeding on to 114, the carrier fibers provided at 108 and the binder fibers provided at 110 are mixed to form a second, generally homogeneous, blend. In the embodiment disclosed herein, it is contemplated that the second blend of between about 10 percent and about 15 percent by volume of binder fibers and between about 90 percent and about 85 percent by volume of carrier fibers.

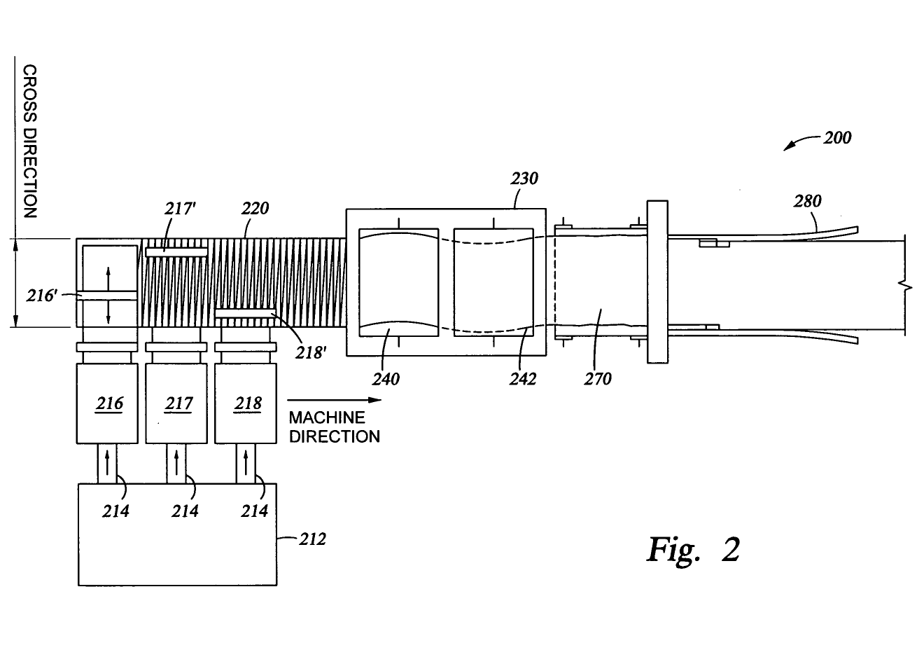

Referring next to FIG. 2, a schematic top plan view of a processing line 200 for forming a heat absorptive bi-layer FR nonwoven fiber batt having a first, FR barrier layer in combination with a second, FR heat-reactive, layer will now be described in greater detail. It should be noted, however, that the description which follows is directed to the formation of a web generally and not to formation of any particular type. Accordingly, the description which follows is equally applicable to formation of a first, barrier, web from a generally homogeneous blend of charring fibers, polyester carrier fibers and polyester binder fibers and to formation of a second, heat reactive web from polyester carrier fibers and polyester binder fibers.

As set forth hereinbove, the specified types of fibers are blended in a fiber blender 212 and conveyed by conveyor pipes 214 to a web forming device or, in the embodiment disclosed herein, first, second and third web forming devices 216, 217 and 218. It is contemplated that a garnett machine is a suitable type of web forming device. Of course, it is fully contemplated that other types of web forming devices would be suitable for the purposes contemplated herein. For example, an air laying device, commonly known in the art as a Rando webber may be used to form the first and/or second web. In the embodiment disclosed herein, the first, second and third web forming devices 216, 217 and 218 card the blended fibers into a nonwoven web having a desired width and deliver the nonwoven web to a corresponding one of first, second and third cross-lappers 216′, 217′, 218′ to cross-lap the nonwoven web onto a slat conveyor 220 moving in the machine direction. First, second and third cross-lappers 216′, 217′ and 218′ reciprocate back and forth in the cross direction from one side of the slat conveyor 220 to the other to form a nonwoven web having multiple thicknesses in a progressive overlapping relationship.

The number of layers which make up the nonwoven web is determined by the speed of the slat conveyor 220 in relation to the speed at which successive layers of the nonwoven web are layered on top of each other and the number of cross-lappers employed as part of the processing line 200. Thus, the number of single layers which collectively make up the nonwoven web can be increased by slowing the relative speed of the slat conveyor 220 in relation to the speed at which the first, second and third cross-lappers 216′, 217′ and 218′ reciprocate, by increasing the number to exceed the three cross-lappers 216′, 217′, 218′ currently shown or both. Conversely, a nonwoven web having a lesser number of single layers can be achieved by increasing the speed of the slat conveyor 220 relative to the speed at which the first, second and third cross-lappers 216′, 217′ and 218′ reciprocate, by reducing the number of cross-lappers below the three cross-lappers 216′, 217′, 218′ currently shown or both.

As disclosed herein, it is contemplated that the number of single layers which collectively make up the barrier web and the number of single layers which collectively make up the heat-reactive web can be approximately the same or can vary depending on the desired characteristics of the heat absorptive bi-layer FR nonwoven fiber batt to be constructed. Accordingly, it is contemplated that the speed of the slat conveyor 220 relative to the speed at which the first, second and third cross-lappers 216′, 217′, 218′ reciprocate and/or the number of cross-lappers 216′, 217′, 218′ used to form the first web may differ from that used to form the second web. In the embodiment disclosed herein, the barrier web and the heat reactive web have thicknesses generally equal to one another. Accordingly, it is contemplated that the slat conveyor 220 is operated at the same speed when forming both the barrier web at 116 (see FIG. 1) and the heat reactive web at 118 (see FIG. 1).

Referring back to FIG. 1, for the configuration of the heat absorptive bi-layer FR nonwoven fiber batt which includes a first, barrier, layer in combination with a second, heat reactive, layer, the process 100 includes forming a barrier web at 116, forming a heat reactive web at 118 and disposing a surface of the barrier web in a conforming relationship to a surface of the heat reactive web.

While it is fully contemplated that a variety of thermal bonding processes may be used as part of the formation of the heat absorptive bi-layer FR nonwoven fiber batt at 122 from the, now disposed, barrier and heat reactive webs, one such method comprises holding the heat reactive and barrier webs using vacuum pressure applied through perforations of first and second counter-rotating drums and heating the heat reactive and barrier webs so that: (1) the relatively low melting temperature binder fibers in the heat reactive web soften or melt to the extent necessary to fuse the low melt binder fibers together and to the carrier fibers; (2) the relatively low melting temperature binder fibers in the barrier web soften or melt to the extent necessary to fuse the low melt binder fibers together and to the FR fibers and the carrier fibers of the barrier web; and (3) the binder fibers in which the binder fibers of each of the heat reactive and barrier webs fuse to the various types of fibers of the other of the webs. Alternatively, the heat reactive and barrier webs may be moved through an oven which melts the low temperature binder fibers of the heat reactive and barrier webs using substantially parallel perforated or mesh wire aprons. And as stated above, alternative boding methods could be employed to bond the heat reactive and barrier layer batts together.

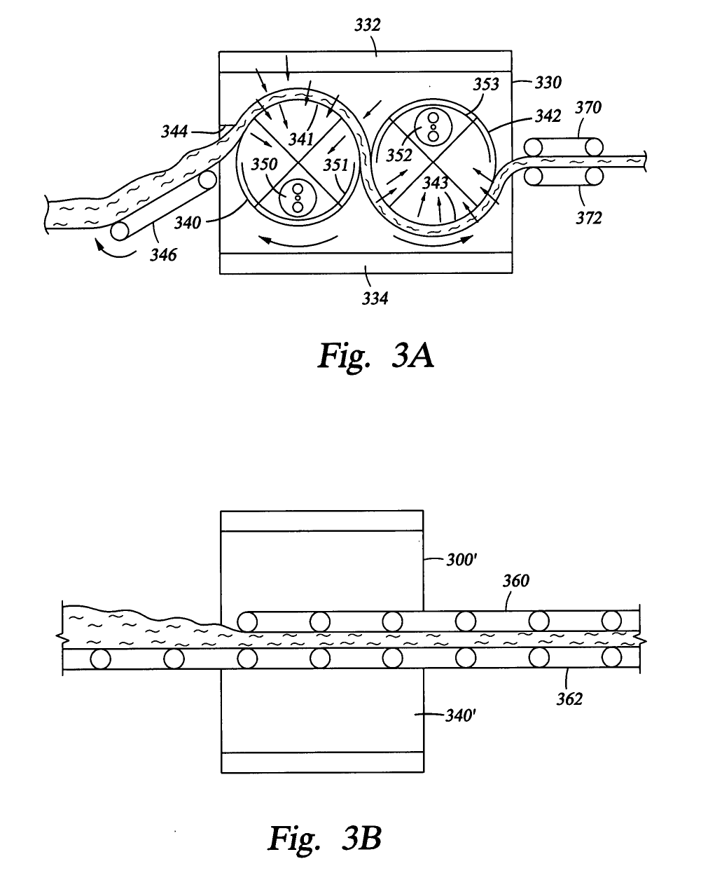

Referring collectively to FIGS. 2 and 3A, the thermal bonding process which utilizes vacuum pressure to construct the neat absorptive bi-layer FR nonwoven fiber batt disclosed herein will now be described in greater detail. As may now be seen, counter-rotating drums 340, 342, each having perforations 341, 343, respectively, are positioned in a central portion of a housing 300. If desired, the drums 340, 342 may be mounted for lateral sliding movement relative to one another, thereby facilitating the adjustment of the drums 340, 342 for a wide range of web thicknesses. Typically, lateral sliding of the drums 340, 342 is enabled using additional components not shown in FIG. 3A. The housing 300 further includes an air circulation chamber 332 in an upper portion thereof and a furnace 334 in a lower portion, thereof. The drum 340 is positioned adjacent an inlet 344 though which the disposed heat reactive and barrier webs are fed. More specifically, an infeed apron 346 delivers the disposed heat reactive and barrier webs to the drum 340. As the drum 340 rotates in a clockwise direction, a suction fan 350 in communication with the interior of the drum 340 creates an air flow which enters the drum 340 through the perforations 341 proximate the upper portion of the drum 340. In the meantime, a baffle 351 shields the lower portion of the drum 340, thereby preventing the air flow from also entering the drum 340 through the perforations proximate the lower portion of the drum 340.

The drum 342 is downstream from the drum 340 in housing 300. Similar to the drum 340, the drum 342 includes a suction fan 352 in communication with the interior of the drum 342 and a baffle 353. As the drum 342 rotates in a counterclockwise direction, the suction fan 352 creates an air flow which enters the drum 340 through the perforations 343 proximate the lower portion of the drum 342. In the meantime, the baffle 352 shields the upper portion of the drum 342, thereby preventing the air flow from also entering the drum 342 through the perforations proximate the upper portion of the drum 340.

The disposed heat reactive and barrier webs are held in vacuum pressure as they moves from the upper portion of the clockwise rotating drum 340 to the lower portion of the counterclockwise rotating drum 342. As the air in the housing 300 flows through the perforations 341, 343 into the respective interiors of the drums 340, 342, the furnace 334 heats the air, to soften or melt the relatively low melting temperature binder fibers include in the heat reactive and barrier webs to the extent necessary to fuse the low melt binder fibers together and to the carrier fibers in the heat reactive web and fuse the low melt binder fibers together and to the carrier and charring fibers in the barrier web.

Referring next to FIG. 3B, in an alternative thermal bonding process, a pair of substantially parallel perforated or mesh wire aprons 360, 362 feed the disposed heat reactive and barrier webs into housing 300′. The housing 300′ includes an oven 340′ which heats the heat reactive and barrier webs) to soften or melt the relatively low melting temperature binder fibers include in heat reactive and barrier webs to the extent necessary to fuse the low melt binder fibers together and to the carrier fibers in the heat reactive web and fuse the low melt binder fibers together and to the carrier and charring fibers in the barrier web).

Next, referring collectively to FIGS. 2 and 3A, as the heat absorptive bi-layer FR nonwoven fiber batt is transported out of the housing 300 by a pair of substantially parallel first and second perforated or wire mesh aprons 370, 372, the heat absorptive FR nonwoven fiber batt is compressed and cooled. If desired, the aprons 370, 372 may be mounted for parallel movement relative to one another, thereby facilitating the adjustment of the aprons 370, 372 for a wide range of batt thicknesses. Variously, the heat absorptive FR nonwoven fiber batt may be slowly cooled through exposure to ambient temperature air or, in the alternative, ambient temperature air can forced through the perforations of one apron 370, 372, through the FR nonwoven fiber batt and then through the perforations of the other apron 370, 372 to cool the heat absorptive bi-layer FR nonwoven fiber batt and set it in its compressed state. The solidification of the low melt temperature binder fibers in the heat reactive layer bonds the low melt binder and carrier fibers to one another. Similarly, the solidification of the low melt temperature binder fibers in the barrier layer bond the low melt binder, carrier and charring fibers to one another. Thusly, the resultant heat absorptive bi-layer FR nonwoven fiber batt is capable of maintaining its compressed state.

The thickness of the finished, fully formed bi-layer FR nonwoven fiber batt (formed from the barrier and heat reactive webs) typically would depend upon the specific uses of the batt and/or the density of the batt. Generally, the density of the fully formed bi-layer batt would be between about 0.5 to about 1.0 ounce per square foot (since this effectively balances performance and loft), and the thickness of the formed batt would be between about 0.25 to about 1.0 inch (with about half the overall batt thickness for each layer in the preferred embodiment). Generally the thickness of the fully formed batt of FIG. 1 is driven by mattress industry needs (regarding comfort, for example), and the thickness of the batt would preferably be between about 0.5 and about 1.0 inches when used on the top surface of a mattress, and would be between about 0.25 and about 0.75 inches when used on the border (side surfaces) of a mattress.

Next, referring collectively to FIGS. 1 and 2, the, now cooled, heat absorptive bi-layer FR nonwoven fiber batt is transported to cutting zone 280. There, the lateral edges of the heat absorptive bi-layer FR nonwoven fiber batt are trimmed at 130 to a finished width. Similarly, the heat absorptive bi-layer nonwoven fiber batt is also cut transversely to a desired length at 132.

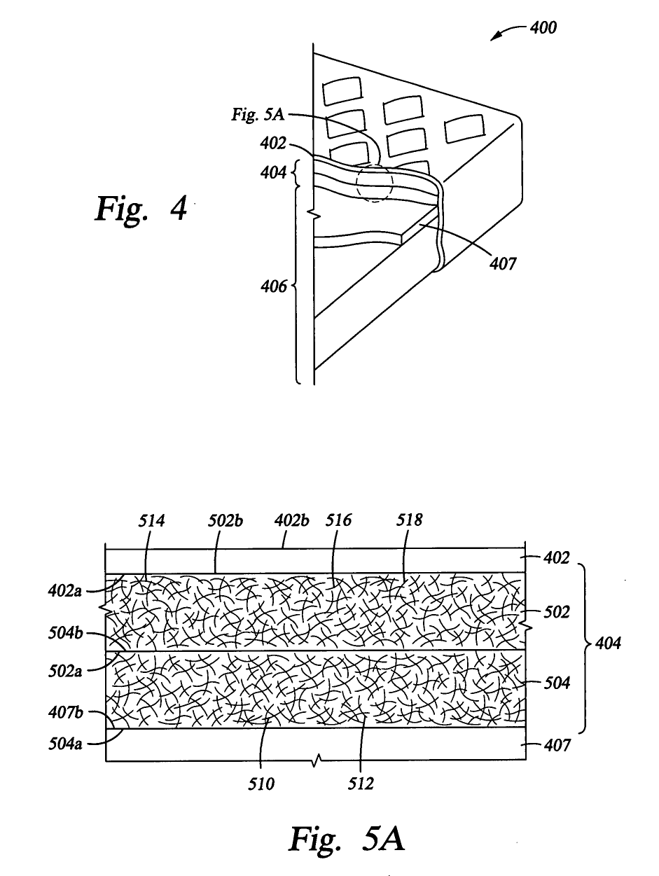

Referring next to FIG. 4, a mattress 400 which includes a heat absorptive bi-layer FR nonwoven fiber batt will now be described in detail. Of course, the mattress 400 is but one of a wide variety of products in which the heat absorptive bi-layer FR nonwoven fiber batt is suitable for incorporation therein. Accordingly, the disclosure of the heat absorptive bi-layer FR nonwoven fiber batt as being incorporated into the mattress should in no way be construed as a limitation as to the type of products in which the heat absorptive bi-layer FR nonwoven fiber batt may be deployed. For ease of comprehension, the foregoing description of the mattress 400 has been greatly simplified and a variety of the components which typically form part of a conventionally configured mattress have either been combined with one or more other conventional components of the matters are have been entirely omitted from the description that follows.

As may be seen in FIG. 4, the mattress 400 may, in a broad sense, be characterized as being comprised of three components—a ticking 402, a heat absorptive bi-layer FR nonwoven fiber batt 404 and a mattress core 406. As defined herein, the mattress core 406 is the combination of a wide variety of components which collectively form the mattress 400. While the mattress core 406 may include a combination of combustible and non-combustible components, for the purposes disclosed herein, the mattress core 406 shall be considered to be a combustible component of the mattress 400. The ticking 402 covers all other components of the mattress 400 and is typically formed of a durable, closely woven fabric. As the ticking 402 is that portion of the mattress 400 visible to a consumer and/or end user of the mattress 400, the ticking 402 is typically formed in a manner intended to result in a pleasing appearance. Thus, tickings are often woven in a plain, satin, or twill weave, usually with strong warp yarns and soft filling yarns.

The heat absorptive bi-layer FR nonwoven fiber batt 404 is positioned between the mattress core 406 and the ticking 402 (and specifically is shown in FIG. 4 between the combustible component layer of the mattress core 406 and the ticking 402). As shown in FIG. 4, the heat absorptive bi-layer FR nonwoven fiber batt 404 covers the top and side surfaces of the mattress core 406, with a lower side surface of the mattress core 406 remaining uncovered. In an alternate embodiment not specifically shown in FIG. 4, the heat absorptive bi-layer FR nonwoven fiber batt 404 is wrapped around the entire mattress core 406.

In still another alternate embodiment not specifically shown in FIG. 4, the heat absorptive bi-layer FR nonwoven fiber batt 404 is merely positioned between a layer forming part of the mattress core 406 and the ticking 402. For example, the mattress core 406 may include a soft, relatively plush, layer 407 provided to enhance the comfort of the mattress 400. However, depending on its specific composition, it is entirely possible that the layer 407 is considered to be combustible. As a result, exposure of the layer 407 to heat will substantially increase the risk of ignition of the mattress 400. To reduce the risk of exposure of the layer 407 to heat, the heat absorptive bi-layer FR nonwoven fiber batt 404 is positioned between the layer 407 and the ticking 402. Of course, rather than positioning the heat absorptive bi-layer FR nonwoven fiber batt 404 between the layer 407 and the ticking 402, it is fully contemplated that the heat absorptive bi-layer FR nonwoven fiber batt 404 may instead be positioned between first and second layers of a mattress. Regardless of the specific placement of the heat absorptive bi-layer FR nonwoven fiber batt 404 relative to other layers of a mattress, as will be more fully described below, the heat absorptive bi-layer FR nonwoven fiber batt 404 will dissipate at least a portion of heat which, in the absence of the heat absorptive bi-layer FR nonwoven fiber batt 404, would otherwise be transferred from one layer of the mattress to the other, a situation which, as previously set forth, may speed ignition of the mattress considerably.

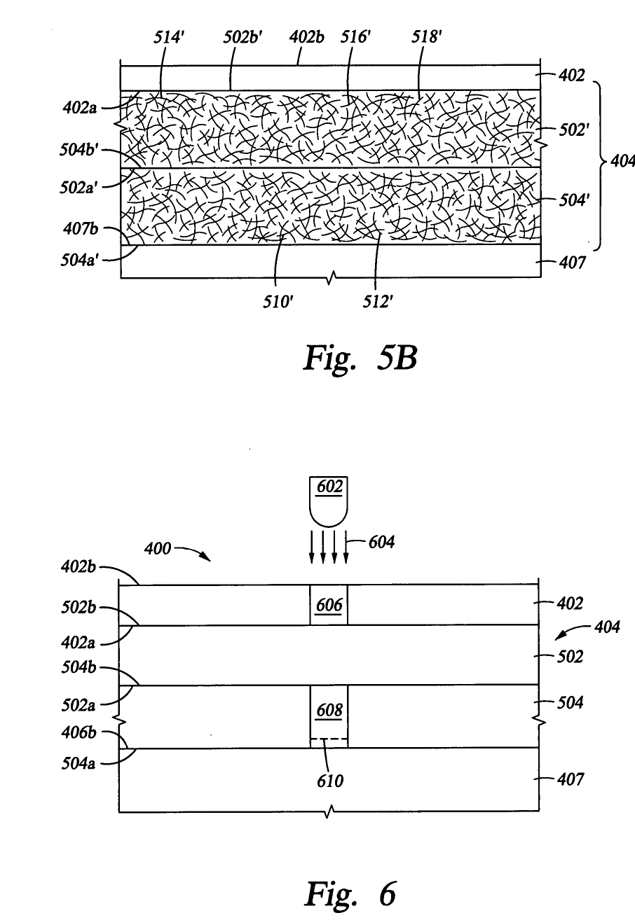

Referring next to FIG. 5A, the heat absorptive bi-layer FR nonwoven fiber batt 404 will now be described in greater detail. As may now be seen, the heat absorptive bi-layer FR nonwoven fiber batt 404 is comprised of a first, barrier layer 502 and a second, heat reactive, layer 504. The heat absorptive bi-layer FR nonwoven fiber batt 404 (which serves as the FR layer of the mattress shown in FIG. 5A) is positioned between the ticking 402 and the combustible layer 407 of the mattress core 406, more specifically, beneath the ticking 402 and above the combustible layer 407. Of course, the ticking 402 and the combustible layer 407 of the mattress core are purely exemplary and it is fully contemplated that the heat absorptive bi-layer FR nonwoven fiber batt 404 may be used to separate any two layers for which the dissipation of heat normally transferred therebetween is desirable.

The barrier layer 502 is comprised of an FR nonwoven fiber batt formed from a blend of binder fibers 514 bonded to carrier fibers 516, barrier-type FR fibers 518 as well as other binder fibers 514. Preferably, the barrier-type FR fibers are charring fibers and, even more preferably, the durable non-inherently FR fibers disclosed in co-pending provision U.S. Patent Application Ser. No. 60/813,378 previously referenced herein and incorporated by reference. While black oxidized PAN or other dark charring fibers are functionally suitable for use as the charring fiber, within a product, the heat absorptive bi-layer FR nonwoven fiber batt 404 is typically positioned such that the barrier layer 502 is positioned closest to the open flame or other heat source and the heat reactive layer 504 is positioned closest to the layer 407 for which minimization of the transfer of heat thereto is desired. So in the example of FIG. 5A, the heat reactive layer 504 is disposed in proximity to the combustible layer 407 (and in this specific example, is shown disposed against the combustible layer 407), while the barrier layer 502 is disposed in proximity to the heat reactive layer 504 but distal to the combustible layer. Accordingly, it is also preferred that the charring or other barrier-type FR fibers are either white or a relative light shade.

The heat reactive layer 504 is comprised of a nonwoven fiber batt formed from a blend of carrier fibers and binder fibers. Commonly, the carrier fibers are polyester carrier fibers and the binder fibers are polyester binder fibers. However, it is fully contemplated that other types of fibers are suitable for the uses contemplated herein. Further, while polyester carrier and polyester binder fibers are both white, as the heat reactive layer 504 is positioned between the barrier layer 502 and the layer 407, it is less important for the heat reactive layer 504 to be formed from white fibers. It is important, however, that the fibers forming the heat reactive layer 504 physically retreat in response to the application of heat originating from an open flame in the proximity thereof. Thus, as polyester fibers are most noted for this type of response to the application of heat thereto, in one embodiment thereof, it is specifically contemplated that the heat reactive layer 504 be comprised of a nonwoven fiber batt formed from polyester binder fibers 510 bonded to polyester carrier fibers 512 as well as to other polyester binder fibers 510.

As may be further seen in FIG. 5A, the barrier layer 502 has a first (or proximal/lower) side surface 502a and a second (or distal/upper) side surface 502b. Similarly, the heat reactive layer 504 has a first (or proximal/lower) side surface 504a and a second (or distal/upper) side surface 504b. The distal side surface of each layer is the side surface distal or farthest from the combustible layer 407 being protected, while the proximal side surface of each layer is the side surface proximal or nearest to the combustible layer 407. Generally, the proximal side surface 504a of the heat reactive layer 504 is disposed in proximity to the combustible layer 407, the proximal side surface 502a of the barrier layer 502 is disposed in proximity to the distal side surface 504b of the heat reactive layer 504, and the ticking 402 is disposed in proximity to the distal side surface 502b of the barrier layer 502.

In the embodiment shown in FIG. 5A, the proximal side surface 504a of the heat reactive layer 504 is disposed against a first (or exterior/upper) side surface 407b of the combustible layer 407. In the embodiment disclosed herein, the proximal side surface 504a of the heat reactive layer 504 is mated with, but not secured to, the upper side surface 407b of the combustible layer 407. In the alternative, however, it is contemplated that the proximal side surface 504a of the heat reactive layer 504 is fixedly secured to the upper side surface 407b of the combustible layer 407. In contrast, the securement of the binder fibers 510 of the heat reactive layer 504 to various ones of the fibers forming the barrier layer 502 and the securement of the binder fibers 514 of the barrier layer to various ones of the fibers forming the heat reactive layer 504 fixedly secures the distal side surface 504b of the heat reactive layer 504 to the proximal side surface 502a of the barrier layer 502. Finally, a first (or interior/lower) side surface 402a of the ticking 402 is disposed against the distal side surface 502b of the barrier layer 502. In the embodiment disclosed herein, the lower side surface 402a of the ticking 402 is mated with, but not secured to, the distal side surface 502b of the barrier layer 502. In the alternative, however, it is contemplated that the lower side surface 402a of the ticking 402 is fixedly secured to the distal side surface 502b of the barrier layer 502.

Referring next to FIG. 5B, an alternate embodiment of the heat absorptive bi-layer FR nonwoven fiber batt 404, hereafter identified as heat absorptive bi-layer FR nonwoven fiber batt 404′ will now be described in greater detail. As may now be seen, the heat absorptive bi-layer FR nonwoven fiber batt 404′ is comprised of a first, barrier layer 502′ and a second, heat reactive, layer 504′. The heat absorptive bi-layer FR nonwoven fiber batt 404′ is positioned between the ticking 402 and the combustible layer 407 of the mattress core 406, more specifically, beneath the ticking 402 and above the combustible layer 407. Of course, the ticking 402 and the combustible layer 407 of the mattress core are purely exemplary and it is fully contemplated that the heat absorptive bi-layer FR nonwoven fiber batt 404′ may be used to separate any two layers for which the dissipation of heat normally transferred therebetween is desirable.

The barrier layer 502′ is comprised of a FR nonwoven fiber batt formed from a blend of binder fibers 514′ bonded to carrier fibers 516′, Visil® fibers 518′ and other binder fibers 514′. Rather than the Visil® fibers 518′, in an alternate embodiment thereof, the barrier layer 502′ may instead include an organic, inorganic or hybrid type of fiber which, like Visil(g, is generally characterized as a permanently FR fiber that neither melts nor flows when in contact with heat or flame. The Fr fibers may be either inherently FR or non-inherently FR fibers. The heat reactive layer 504′ is comprised of a nonwoven fiber batt formed from a blend of binder fibers 510′, preferably polyester binder fibers, bonded to carrier fibers 512′, preferably polyester carrier fibers, and other binder fibers 510′.

As may be further seen in FIG. 5B, the barrier layer 502′ has a first (or proximal/lower) side surface 502a′ and a second (or distal/upper) side surface 502b′. Similarly, the heat reactive layer 504′ has a first (or proximal/lower) side surface 504a′ and a second (or distal/upper) side surface 504b′. The proximal side surface 504a′ of the heat reactive layer 504′ is disposed against a first (or exterior/upper) side surface 407b of the combustible layer 407. In the embodiment disclosed herein, the proximal side surface 504a′ of the heat reactive layer 504′ is mated with, but not secured to, the upper side surface 407b of the combustible layer 407. In the alternative, however, it is contemplated that the proximal side surface 504a′ of the heat reactive layer 504′ is fixedly secured to the upper side surface 407b of the combustible layer 407. In contrast, the securement of the binder fibers 510′ of the heat reactive layer 504′ to various ones of the fibers forming the barrier layer 502′ and the securement of the binder fibers 514′ of the barrier layer 502′ to various ones of the fibers forming the heat reactive layer 504′ fixedly secures the distal side surface 504b′ of the heat reactive layer 504 to the proximal side surface 502a′ of the barrier layer 502′. Finally, a first (or interior/lower) side surface 402a of the ticking 402 is disposed against the distal side surface 502b′ of the barrier layer 502′. In the embodiment disclosed herein, the lower side surface 402a of the ticking 402 is mated with, but not secured to, the distal side surface 502b′ of the barrier layer 502′. In the alternative, however, it is contemplated that the lower side surface 402a of the ticking 402 is fixedly secured to the distal side surface 502b′ of the barrier layer 502′.

Referring next to FIG. 6, the response of the heat absorptive bi-layer FR nonwoven fiber batt 404 to a heat source and the resultant effect that the response of the heat absorptive bi-layer FR nonwoven fiber batt 404 will have on the potential for ignition of the mattress 400 will now be described in greater detail. As illustrated herein, the heat source 602 is an open flame in proximity to the mattress 400. In FIG. 6, the heat source 602 is located in distal proximity to the barrier layer 502 (such that the heat source 602 is located beyond the distal side surface 502b of the barrier layer 502, with the barrier layer 502 located between the heat source 602 and the combustible layer 407), beyond the ticking 402 that surrounds the mattress 400. It should be readily appreciated, however, that a wide variety of other heat sources, for example, a space heater or other type of heat generating electrical appliance commonly found in a household, may be the source of heat creating the risk of potential ignition of the mattress 400.

The open flame 602 generates heat 604 which radiates outwardly, from the open flame 602, towards the mattress 400. As representatively illustrated in FIG. 6, only the heat 604 generated in a direction generally orthogonal to the mattress 400 is shown. It should be clearly understood, however, that an open flame more commonly tends to radiate heat omnidirectionally rather than the unidirectional pattern shown in FIG. 6. As is common in the bedding industry, the ticking 402 is formed using polyester or another heat reactive fiber that tends to retreat rapidly in the presence of the heat 604 radiating from the open flame 602, thereby forming an aperture 606 in the ticking 402 which exposes the barrier layer 502 of the heat absorptive bi-layer FR nonwoven fiber batt 404. As illustrated herein, the aperture 606 appears to have been formed in a generally tubular shape. Such a result would typically occur if the heat 604 radiated from the open flame 602 in the pattern illustrated in FIG. 6. Omnidirectionally radiating heat, on the other hand would result in the aperture 606 have a much more uneven shape, including some portions that have fully penetrated the ticking 402, other portions that have merely partially penetrated the ticking 402 and a relatively jagged periphery resulting from a non-uniform retreat of the ticking 402 from the heat 604 generated by the open flame 602.

Upon fully penetrating the ticking 402, the heat 604 continues radiating towards the barrier layer 502. Oftentimes, the heat 604 is accompanied by a corresponding travel of the open flame 602 generating the heat 604 (with the open flame generally contacting the distal side surface 502b of the barrier layer 502). Unlike the ticking 402, however, the barrier layer 502 does not physically retreat in the presence of the heat 604 generated by the open flame 602. Instead, the barrier layer 502 will maintain its structural integrity. For example, if the barrier layer 502 is formed using a charring fiber such as a durable FR rayon, the fibers will form a stable char structure when exposed to the open flame 602. Conversely, if formed using a permanently FR fiber such as Visil®, the permanently FR fibers will neither melt nor flow when placed in contact with the open flame 602. In either case, the charring or Visil® fibers will enable the barrier layer 502 to maintain its structural integrity, thereby preventing further penetration of the open flame 602 into the interior of the mattress 400 by shielding the heat reactive layer 504 and the combustible layer 407 from experiencing direct contact with the open flame 602. As a result, the barrier layer 502 will successfully prevent further degradation of the structural integrity of the mattress 400 for a measurable period of time.

While the barrier layer 502 will prevent further penetration of the open flame 602, the barrier layer 502 does permit a portion of the heat 604 generated by the open flame to radiate through the barrier layer 502. Typically, roughly 20% of the heat 604 generated by the open flame 602 will tend to radiate through the barrier layer 502. Having successfully penetrated the barrier layer 502, the heat will again encounter a heat reactive layer formed from polyester or other heat reactive fibers. As before, the polyester fibers forming the heat reactive layer 504 will retreat rapidly in the presence of the heat successfully radiating through the barrier layer 502, thereby forming an aperture 608 in the heat reactive layer 504. So in reaction to the heat, the portion of the heat reactive layer 504 experiencing heat retreats such that an aperture 608 will form in the heat reactive layer 504, extending from the distal side surface 504b to an interior side surface 610 thereof (or in a worst case scenario, extending to the proximal side surface 504a of the heat reactive layer 504).

As illustrated herein, the aperture 608 again appears to have been formed in a generally tubular shape. As before, however, such a result would typically occur if the heat 604 radiates from the open flame 602 in the pattern illustrated in FIG. 6. Omnidirectionally radiating heat, on the other hand would result in the aperture 610 have a much more uneven shape, including some portions that have fully penetrated the heat reactive layer 504, other portions that have merely partially penetrated the heat reactive layer 504 and a relatively jagged periphery resulting from a non-uniform retreat of the heat reactive layer 504 from the heat 604 generated by the open flame 602.

Depending on the amount of heat radiating through the barrier layer 502 and/or the thickness of the heat reactive layer 504, the aperture 608 may expose an interior side surface 610 (shown in phantom in FIG. 6) or, in the worst case scenario, expose the combustible layer 407 of the mattress 400, an event that significantly raises the potential for ignition of the mattress 400 itself or, more likely, consumption of a sufficient large portion of the combustible layer 407 such that the mattress 400 begins to experience structural failure. This is particularly true in situations where the open flame is capable of traveling through the aperture 608 towards the combustible layer 407 (although in this instance, the barrier layer should tend to prevent or delay penetration of the flame). Here, rather than forming a path for the open flame 602 to travel towards the combustible layer 407, the aperture 608 serves as a heat sink which impedes thermal transfer by absorbing heat which would otherwise radiate towards the combustible layer 407. Thus, rather than heating and potentially igniting the combustible layer 407 (an event which normally precedes the structural failure of the mattress 400), heat radiating through the barrier layer 502 would merely heat the air within the aperture 608 (with the aperture 608 serving to insulate the combustible layer 407 from the heat for a time). At the same time, the char structure formed by the exposure of the barrier layer 502 to the open flame 602 would release gas and steam energy, thereby resulting in a general cooling of the mattress 400.

In this manner, the heat absorptive bi-layer FR nonwoven fiber batt provides two discrete responses, each of which tends to suppress the combustion of a product having the heat absorptive bi-layer FR nonwoven fiber batt incorporated therein. More specifically, exposure of an outer, barrier, layer of the heat absorptive bi-layer FR nonwoven fiber batt to an open flame will result in the formation of a char structure that tends to cool the product and to shield the heat reactive layer from direct contact with the heat source. A portion of the heat generated by the open flame radiates through the barrier layer, causing the formation of an aperture in the underlying heat reactive layer. Once formed, heat radiating through the barrier layer will tend to heat air in the aperture rather than the combustible layer covered by the heat reactive layer. This, too, will tend to suppress the combustion of the product.

Optionally, a chemical barrier layer may be applied to the distal (exterior) side surface of the heat absorptive bi-layer FR nonwoven fiber batt (i.e. to the side surface which is likely to experience a heat source). While not required, such an optional chemical barrier layer may serve to enhance the FR characteristics of the barrier layer of the heat absorptive bi-layer FR nonwoven fiber batt. The chemical barrier layer may comprise oxygen depleting chemicals, which may be sprayed or foamed onto the distal side surface of the barrier layer. As an example, a chemical barrier layer could comprise phosphorus-based FR chemicals, such as multipolyphosphate. Such oxygen depleting chemicals would off-gas when heated (by a flame, for example), displacing oxygen with a nonflammable gas in order to deprive the flame of oxygen. Typically, the chemical barrier layer would be at least about 5% by weight of the overall product (batt), and when used with a heat absorptive bi-layer FR nonwoven fiber batt, preferably about 10% or more of the weight of the batt. The chemical barriers specifically described above are merely intended to serve as examples, and alternatives are included within the scope of this disclosure. Additionally, the chemical barrier may be used with a single-layer FR batt similar to the barrier layer described above, even without the inclusion of a heat-reactive layer. Chemical barrier layers and single-layer FR batts are described in more detail in co-pending application Ser. No. ______ (4003-22400 monoloft) entitled “Fire Resistant Barrier Having Chemical Barrier Layer”, which is incorporated by reference herein as if fully recited.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Accordingly, the scope of protection is not limited by the description set out above, but is defined by the claims which follow, that scope including all equivalents of the subject matter of the claims. Furthermore, any advantages and features described above may relate to specific embodiments, but shall not limit the application of such issued claims to processes and structures accomplishing any or all of the above advantages or having any or all of the above features.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings refer to a “Field of the Invention,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of the claims shall be considered on their own merits in light of this disclosure, but should not be constrained by the headings set forth herein.

What is claimed is:

1. A heat absorptive bi-layer fire resistant (“FR”) nonwoven fiber batt for use with a product having a combustible layer, comprising:
a barrier layer having a distal side surface distal to the combustible layer and a proximal side surface proximal to the combustible layer; and
a heat reactive layer having a distal side surface distal to the combustible layer and a proximal side surface proximal to the combustible layer;
wherein the proximal side surface of the barrier layer is disposed against the distal side surface of the heat reactive layer.

2. A heat absorptive bi-layer FR nonwoven fiber batt as in claim 1, wherein:
the barrier layer comprises FR fibers that neither melt nor flow when in contact with heat; and
the heat reactive layer comprises fibers that physically retreat in response to the application of heat.

3. A heat absorptive bi-layer FR nonwoven fiber batt as in claim 2, wherein in response to the application of heat originating from a heat source in distal proximity to the barrier layer, a portion of the heat reactive layer which experiences heat from the heat source retreats to form an aperture that impedes thermal transfer of heat from the heat source to the proximal side of the heat-reactive layer.

4. A heat absorptive bi-layer FR nonwoven fiber batt as in claim 1, wherein: the barrier layer comprises an FR nonwoven fiber batt that does not physically retreat, but maintains structural integrity, in response to the application of heat; and the heat reactive layer comprises a nonwoven fiber batt that physically retreats in response to the application of heat.

5. A heat absorptive bi-layer FR nonwoven fiber batt as in claim 4, wherein in response to the application of heat originating from a heat source in distal proximity to the barrier layer:
the barrier layer is operable to shield the heat reactive layer from direct contact with the heat source while permitting a portion of the heat generated by the heat source to radiate through; and
the heat reactive layer is operable to form an aperture that impedes thermal transfer of heat from the heat source to the proximal side of the heat reactive layer as a portion of the heat reactive layer experiencing heat retreats.

6. A heat absorptive bi-layer FR nonwoven fiber batt as in claim 5, wherein the aperture extends from the distal side surface of the heat reactive layer to an interior side surface thereof.

7. A heat absorptive bi-layer FR nonwoven fiber batt as in claim 5, wherein:
the product further comprises a ticking;
the ticking is disposed against the distal side surface of the barrier layer; and
the proximal side surface of the heat reactive layer is disposed against the combustible layer.

8. A heat absorptive bi-layer FR nonwoven fiber batt as in claim 5, wherein the FR nonwoven fiber batt of the barrier layer comprises inherently FR fibers.

9. A heat absorptive bi-layer FR nonwoven fiber batt as in claim 8, wherein the inherently FR fibers comprise oxidized polyacrylonitrile fibers.

10. A heat absorptive bi-layer FR nonwoven fiber batt as in claim 5, wherein the FR nonwoven fiber batt of the barrier layer comprises hybrid fibers that neither melt nor flow when in contact with heat.

11. A heat absorptive bi-layer FR nonwoven fiber batt as in claim 10, wherein the hybrid fibers comprise Visil fibers.

12. A heat absorptive bi-layer FR nonwoven fiber batt as in claim 5, wherein the FR nonwoven fiber batt of the barrier layer comprises non-inherently FR fibers treated with a fire retardant chemical.

13. A heat absorptive bi-layer FR nonwoven fiber batt as in claim 5, wherein the FR nonwoven fiber batt of the barrier layer comprises FR rayon fibers.

14. A heat absorptive bi-layer FR nonwoven fiber batt as in claim 5, wherein the FR nonwoven fiber batt of the barrier layer comprises charring fibers.

15. A heat absorptive bi-layer FR nonwoven fiber batt as in claim 14, wherein the charring fibers comprise durable FR rayon.

16. A heat absorptive bi-layer FR nonwoven fiber batt as in claim 14, wherein the barrier layer is operable to release gas and steam when exposed to the heat source.

17. A heat absorptive bi-layer FR nonwoven fiber batt as in claim 5, wherein the nonwoven fiber batt of the heat reactive layer comprises polyester fibers.

18. A method for enhancing the fire resistance characteristics of a product having a combustible layer, comprising:
positioning a heat reactive layer having a distal side surface distal to the combustible layer and a proximal side surface proximal to the combustible layer, with the proximal side surface of the heat reactive layer disposed in proximity to the combustible layer; and
positioning a barrier layer having a distal side surface distal to the combustible layer and a proximal side surface proximal to the combustible layer, with the proximal side surface of the barrier layer disposed in proximity to the distal side surface of the heat reactive layer.

19. A method as in claim 18, further comprising joining the barrier layer and the heat reactive layer to form a heat absorptive bi-layer fire resistant nonwoven fiber batt.

20. A method as in claim 18, wherein the product further comprises a ticking, the method further comprising positioning the ticking, with the ticking disposed in proximity to the distal side surface of the barrier layer.

21. A product comprising:
a combustible layer;
a ticking; and
an FR layer;
wherein:
the FR layer comprises a barrier layer and a heat reactive layer;
the heat reactive layer comprises a nonwoven fiber batt operable to physically retreat in response to the application of heat;
the barrier layer comprises an FR nonwoven fiber batt operable to not physically retreat, but maintain structural integrity, in response to the application of heat; and
the FR layer is disposed between the combustible layer and the ticking.

22. A product as in claim 21, wherein:
the heat reactive layer is disposed in proximity to the combustible layer; and
the barrier layer is disposed in proximity to the heat reactive layer and distal to the combustible layer.

23. A product as in claim 21, wherein:
the barrier layer comprises a distal side surface distal to the combustible layer and a proximal side surface proximal to the combustible layer;
the heat reactive layer comprises a distal side surface distal to the combustible layer and a proximal side surface proximal to the combustible layer;
the proximal side surface of the barrier layer is disposed in proximity to the distal side surface of the heat reactive layer; and
the proximal side surface of the heat reactive layer is disposed in proximity to the combustible layer.
